(19) United States
(12) Patent Application Publication
(10) Pub. No.: US 2007/0078528 A1
(43) Pub. Date: Apr. 5, 2007

(54) Predictive fault determination for a non-stationary device

(76) Inventors: Juergen Anke, Dresden (DE); Mario Neugebauer, Dresden (DE); Gregor Hackenbroich, Dresden (DE)

Correspondence Address: KENYON & KENYON LLP, ONE BROADWAY, NEW YORK, NY, 10004, US

(21) Appl. No.: 11/303,677

(22) Filed: Dec. 15, 2005

Related U.S. Application Data
(60) Provisional application No. 60/719,539, filed on Sep. 21, 2005.

(51) Int. Cl. G05B 11/01; G05B 13/02; G05B 9/02

(52) U.S. Cl. 700/21; 700/79; 700/44

(57) ABSTRACT

A predictive fault determining system includes a non-stationary operating device and a stationary fault determining device that communicates with the operating device using wireless transmissions. The non-stationary operating device includes sensors determining status data of the operating device and a processing device to combine the status data, generating a status signal and wirelessly transmitting the status signal to the fault determining device. Using a wireless receiver, the fault determining device extracts the status data and calculates condition data for the operating device including condition levels, indicating a likelihood of at least one operational failure. Wirelessly, a condition data signal having the condition levels therein is transmitted to the non-stationary operating device, such that the resident processing device may determine if a warning notification should be generated based on selecting a condition level for various elements by comparing the status data to the condition data.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to predictive maintenance identification in an operating device and more specifically to the distribution of decision support using product embedded information devices. Specifically, the present invention is intended to predict a time of failure for one or more components of the operating device (e.g. a motor vehicle) based on the active measured conditions for the device's components.

Existing predictive maintenance systems allow for early determinations of anticipated problems with operational devices. In these systems, product embedded information devices (PEIDs), which may be embodied as sensors, record the various operational aspects of a device. These PEIDs can record various factors, such as oil pressure, fluid levels, operating efficiency, time since previous repairs, locations, and other factors.

Existing predictive maintenance systems offer two options for calculating any likelihood of element failure. A first technique is a resident calculation technique in which an on-board computing system analyzes the sensor data. This technique is typically found in non-stationary devices, which can be devices that are themselves mobile or included in a mobile environment. One example of a non-stationary device is construction equipment, such as a dump truck. The truck may be on a construction site and traveling between various locations during the work day.

Due to size and processing limitations, the non-stationary devices do not have the capacity for sophisticated levels of computation. These systems can provide basic computing ability, which typically consists of comparing a sensor data reading to a chart of ranges. If the sensor data is outside of the range, the processing device may then provide a cursory notification. For example, if the oil level is below a threshold level, an oil light may be illuminated. In more advanced systems, more informative visual displays may be provided, such as on an LCD screen. The on-board computing system may also be able to monitor time delays relative to various factors, such as monitoring time and/or mileage between maintenance schedules for a vehicle. These on-board systems are restricted to basic computations of a binary determination of whether a component's operation is either inside or outside of a predetermined operating range. Similarly, these systems are self-contained systems so the only available computational data is the information installed on the on-board computer and the information acquired by the sensors.

The second technique for predictive maintenance is with stationary devices having a direct continuous connection to one or more processing systems. This technique is typically found in large industrial applications with fixed equipment. For example, an industrial molding machine may include a large number of PIEDs that monitor a large variety of aspects of the machine's operation. These stationary devices do not include any significant amount of internal computing power relating to the sensors, but rather upload the sensor data to the connected processing system.

This processing system can use its large available processing capabilities to perform significant amounts of data processing. The processing system can perform large amounts of data analysis to not only assess the status of the stationary device, but also calculate predictive maintenance issues. For example, based on the data from various sensors, the processing device may determine that a particular component is likely to need replacement in several months or several days.

The processing device connected to the stationary device allows a much greater amount of predictability. Similarly, the processing device is not limited to information solely from the station device itself, but may also use data from other stationary devices using networked communications.

The improvements of predictive maintenance using the connected computer for a stationary device are not realizable by non-stationary devices. Using the above-noted example of the truck, this truck is constantly being driven around different worksites. The non-stationary equipment does not have the ability for a dedicated connection to a back-end processing system because of its mobility and problems associated with proper communication between any back-end system and the non-stationary device.

Another example of a non-stationary device may be an automobile. While many automobiles include sophisticated computing systems and wireless communication systems, predictive maintenance is typically performed when the vehicle is being serviced, that is when the vehicle is temporarily in a stationary state. During servicing, a technician physically connects a processing computer to the vehicle's on-board computer. Through this direct physical connection, different maintenance routines can be run to provide a snapshot of the vehicle as well as provide predictive maintenance information. Again though, this technique still requires physical connection and the intermittent review of status data.

With a non-stationary device, the limitation of available processing resources and the limited data sets usable for determining predictive maintenance significantly limit the device's ability to warn any user of pending operational concerns. Similarly, the mobility of the non-stationary device limits access to the advanced processing capabilities available to the stationary devices.

### BRIEF DESCRIPTION OF THE DRAWINGS

FIG. 1 illustrates a block diagram of one embodiment of a fault determining device;

FIG. 2 illustrates one embodiment of a non-stationary operating device;

FIG. 3 illustrates one embodiment of a predictive fault determining system;

FIG. 4 illustrates another embodiment of a predictive fault determining system;

FIG. 5 illustrates a flow chart having the steps of one embodiment of a method for determining predictive fault determinations for a non-stationary operating device; and

FIG. 6 illustrates the steps of one embodiment of a method for determining predictive fault determination for a non-stationary operating device.

### DETAILED DESCRIPTION OF THE INVENTION

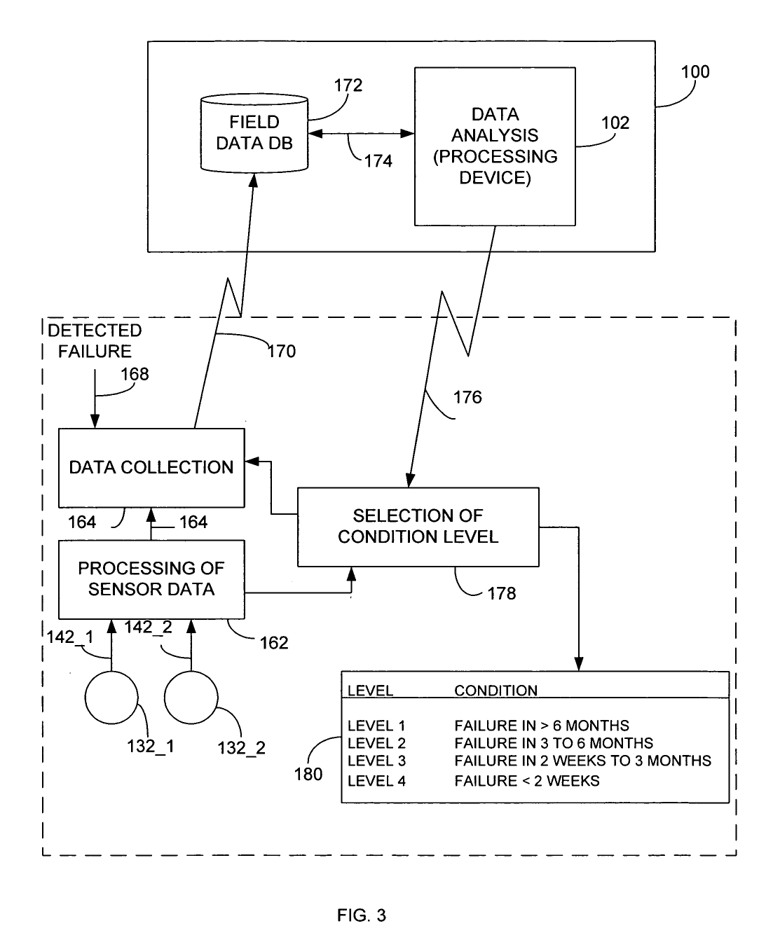

Generally, a predictive fault determining system includes a non-stationary operating device and a fault determining device. The term non-stationary operating device may refer to an operating device that is in motion and this terminology may also refer to an operating device that is temporarily stationary, but has the capacity, as part of its normal operating and in order to fulfill its intended purpose, to move (i.e., enter into a non-stationary state). The fault determining device is stationary and communicates with the non-stationary operating device using a wireless transmission. The non-stationary operating device includes sensors to determine status data of one or more components of the operating device. Normally, the operating device uses sensors data to select a condition level from one of a plurality of levels, expressing varying degrees of device degradation, an example of which is table 180 of FIG. 3. The non-stationary operating device further includes a processing device to combine the status data to generate a status signal and wirelessly transmit the status signal to the fault determining device. Using a wireless receiver, the fault determining device extracts the status data and calculates condition data for the operating device based on the status data. The condition data includes condition level data that indicate a likelihood of at least one operational failure within a defined time interval. Wirelessly, a condition data signal having the condition data therein is transmitted to the non-stationary operating device. The resident processing device thereupon more accurately determines if a warning notification should be generated by comparing the status data of the operating device to the condition levels, including selecting one of the condition levels for various component based on the comparison. Therefore, through the utilization of a wireless transmission, an improved processing and predictive fault determination may be performed by a back end processing systems without affecting the mobility of the non-stationary device.

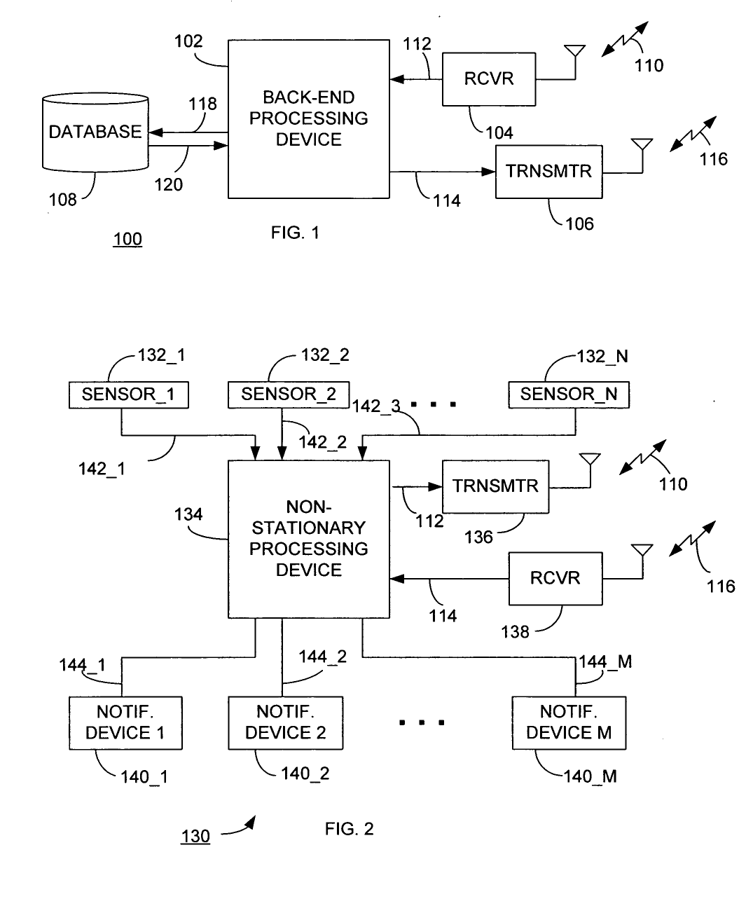

FIG. 1 illustrates a block diagram of one embodiment of a fault determining device 100 including a back end processing device 102, a wireless receiver 104, and a wireless transmitter 106. In one embodiment, the fault determining device 100 includes a database 108. Although the embodiments described herein pertain to non-stationary devices, the invention is intended to encompass stationary devices as well.

The back end processing device 102 may be one or more processing devices capable of performing various calculations and other executable operations based on operating instructions. The back end processing device 102 may be similar to dedicated processing devices associated with fault determining systems for stationary devices, and the processing device 102 may be connected to one or more other processing devices in a computing network. The receiver 104 and the transmitter 106 may be any suitable devices capable of wirelessly receiving and wirelessly transmitting signals to a corresponding device within a prescribed transmission range. It is recognized that the receiver 104 and transmitter 106 may include access to further communication networks not specifically illustrated herein, for example, the receiver 104 and transmitter 106 may be interconnected through one or more wireless networks or in another embodiment may be a standard wireless routing device relative to the back end processing device 102.

In one embodiment, the receiver 104 is operative to wirelessly receive an incoming wireless transmission 110 that includes an operational status signal 112. The receiver 104 provides the operational status signal 112 through the back end processing device 102, wherein the processing device 102 is operative to, in response to executable instructions, extract status data. The level of transmission 110 received by the receiver 104 is provided from a non-stationary operating device (not shown). This status data extracted from the status signal includes the data relating to the operating device, and recorded information about specific operational aspects as described in further detail below.

The back end processing device 102 is further operative to calculate condition data for the operational device based on the status data. The condition data includes condition levels that indicate a likelihood of an operational failure by the operating device within one of a plurality of time periods, including threshold values for component operations. As described in further detail below, if the condition data indicates that a particular component is likely to fail within a time period, for example, between 3 months and 6 months, the back end processing device may determine that no immediate action may be required. It is recognized that the condition data may relate to any number of components or to the whole operating device itself. For example, the operating device may have any number of components that are subject to failure. In the example of an automobile, the condition of an air filter, oil filter, coolant levels, and many other aspects may be monitored. In another example maintenance may relate to time required for general maintenance such as a scheduled oil change or other types of maintenance activity.

With the condition data calculated, which may include the various condition levels, a condition data signal 114 is provided to the transmitter 106. The transmitter 106 may thereupon provide a wireless transmission 116 directed to the non-stationary operating device (not shown). In one embodiment, the transmitter 106 may reserve transmission of the wireless signal 116 until confirmation that the non-stationary operating device is within a transmission range. For example, the non-stationary operating device may ping the fault determining device to transmit a wireless signal 116.

In another embodiment illustrated in FIG. 1, the fault determining device 100 may further utilize the database 108 to determine the condition data. The database 108 includes status data from any number of different non-stationary operating devices. The database 108 may further include additional information from a variety of sources, including information from a parts manufacturer relating to maintenance issues. In this embodiment, the back end processing device 102 may provide a retrieve request 118 to the database 108 to retrieve additional status data 120 therefrom. In this embodiment, the condition levels of the condition data may then be calculated based on the status data 112 and the additional status data 120 from the database 108.

In one embodiment, the processing device 102 may calculate the condition levels by comparing the sensor data to sensor data guidelines. The sensor data guidelines may be set by any number of available techniques, including operational experience from similar non-stationary devices, information from manufacturers or suppliers, or any other suitable sources. The processing device 102 may thereupon estimate a failure time for a plurality of the components in the operational device based on the comparison of the sensor data to the sensor data guidelines. In another embodiment, the condition levels may not be adjusted. In that instance, various techniques may be utilized including not sending a condition signal, sending a now duplicative condition signal, sending a message indicating there are no changes to the condition level or any other available technique recognized by one skilled in the art.

FIG. 2 illustrates one embodiment of a non-stationary operating device 130 that includes a plurality of sensors 132 (illustrated as sensors 132_1, 132_2 and 132_N, where N may be any integer number), a processing device 134, a wireless transmitter 136, a wireless receiver 138, and a plurality of notification devices 140 (illustrated as devices 140_1, 140_2 and 140_M, where M may be any integer number).

The sensors 132 may be any suitable type of sensor operative to monitor and to. report the status of particular operational devices or elements. For example, a sensor may be an oil pressure measuring device to calculate the oil pressure in a combustion engine. Another sensor may measure fluid levels in an automobile. The sensor 132 may be a passive device such as an RFID tag reading specific location information. The non-stationary processing device 134 may be any suitable processing device operative to perform various operation in response to executable instructions. The processing device 134 may be a combination of hardware and software components for performing operations associated with the executable instructions. The transmitter 136 and receiver 138 may be similar to the receiver 104 and transmitter 106 of FIG. 1 embedded in the fault-determining device 100. In one embodiment, the transmitter 136 and receiver 138 may include limited functionalities to consider power and other associated concerns relative to the non-stationary device 130. The notification device 140 may be any suitable type of device providing notification to a user. For example, a notification device may be a light on a dashboard or other LED indicating repairs are necessary or an audio device providing an audible notification or other type of notification device. In another embodiment, the notification device may be visual display, for instance an LCD screen providing a computer readout. It is recognized that any suitable device may be utilized to provide a corresponding notification.

In the non-stationary operating device 130, the sensors 132 determine the status data 142 by monitoring corresponding operations. The generation of the status data 142 may be in accordance with known existing sensor techniques. The status data 142 may also include specific sensor, PEID or non-stationary device identifiers to different the status data 142 for each component from the other components in the non-stationary device, as well as all other components that may be processed by a back end processing system. Using the status data 142, the processing device 134 is operative to combine the status data 142 to generate a status signal 144. When the non-stationary operating device 130 is within a transmission range of a fault determining device (100 of FIG. 1), the transmitter 136 is operative to wirelessly transmit the status signal 112 in the wireless transmission 110. As described above, the fault determining device 100 of FIG. 1 thereupon performs operations to calculate the condition data associated with elements in the non-stationary operating device 130. When the device 130 is within transmission range, the receiver 138 is operative to receive wireless transmission 116 from the transmitter 106 of FIG. 1. The condition data signal 114 is then received by the processing device 134.

The processing device 134 is thereupon operative to determine if at least one warning notification should be generated based on a comparison of status data 142 to the condition levels of the condition data. For example, the condition data may include level indicators for more of the various operating elements to be compared to the collected status data. Using the example of a sensor determining efficiency operation of an oil filter, processing device 134 may determine that the oil filter should be replaced within the next few weeks. For this information, a corresponding condition level may be set by comparing the status data 142 to the condition data to set a conditional level to determine if the processing device 134 should provide a notification. If needed, a notification signal 144 may be provided to one of the notification devices 140. In the embodiment where there is no immediate maintenance required, the processing device 134 may avoid sending any type of notification signal to any of the notification devices 140 until a corresponding level indicates appropriately.

FIG. 3 illustrates one embodiment of a fault determining system 160 including the fault determining device 100 and the non-stationary operating device 130. Within the operating device 130, sensors 132_1 and 132_2 monitor components and/or operations of the operating device 130. The sensors 132_1, 132_2 provide status data 142_1, 142_2 to module 162 for processing. The module 162 thereupon provides process data 164 to a data collection module 166. In one embodiment, data collection module 166 may also receive detected failure information 168 which provides for an indication of a failed component or components, instead of monitoring the sensor recording the status of the operation.

With this combined information, the data collection module 164 may.provide status data 170 to a status data storage device 172 within the fault determining device 100. For example, the status data database 172 may store historical recordings of data 170 from the corresponding device 160. The database 172 may also include other information from similar non-stationary devices. Within the fault determining device 100, data analysis may be performed by the processing device 102 using collective status data 174. As described above, condition data is calculated which may include thresholds or value ranges for corresponding component. For example, in one embodiment a range may be determined corresponding to a particular element within the device 130. Another embodiment, the condition data may be an actual level such as a level 2 or a level 3. Regardless of this specific information, the data analysis and processing device 102 provides a corresponding predictive maintenance setting for components based on the status data 142_1, 142_2, detected failure data 168 and additional status data stored in the status data database 172.

The fault determining device 100 may thereupon provide a wireless transmission of status data 176 for the selection of one or more condition levels. A selection module 178 may select one of several various conditions from a table, such as the table 180. For example, for each of the individual components a condition module may be selected based on whether failure will not occur within six months (level 1), failure may occur between three to six months (level 2), failure may occur between two to three months (level 3) or failure may occur in less than two weeks (level 4). The levels on the table 180 and for illustrative purposes only and it is recognized that any number of levels may be utilized. It is based on these levels that the non-stationary device 130 may recognize if one or more components are predicted for pending failure, where these levels are determined by the back end processing system for remote use by the non-stationary device, which may or may not be in a stationary mode (e.g. at rest or in active transitory use).

For illustrative purposes, one example of a non-stationary device may be a motor vehicle. The on-board computer may have limited resources to perform update condition calculations, similarly, the on-board computer will also lack the data for performing this operation. Therefore, numerous PEID determine various levels of status information. For example, one device may monitor the quality and/or quantity of air received through an air-intake mechanism. The sensor generates corresponding sensor information, which is combined with many other sensor data to be transmitted to the back end processing system.

This air intake sensor data, as well as the other sensor data, is also compared with existing condition level information to determine if there is a predictable imminent failure. The motor vehicle, after transmitting the status data to the back end processing system, may also receive the updated condition data that may include numerous levels, e.g. levels 1-4 as illustrated in table 180 of FIG. 3. This condition data may include 4 levels for the air filter based on the air intake sensor. The measurements taken by the air intake sensor are then compared to this updated level information to determine a corresponding level for the air filter. The corresponding level for the air is determined and further predictive maintenance actions may or may not be warranted, where the air filter's condition is determined based on the updated condition data determined by the back end processing system having a greater degree of a status data information and processing capabilities. This updated condition data may provide a greater degree of predictability for the component, in this example an air filter, because the condition levels may be updated from previous levels based on more status information. For example, previous condition levels may indicate that a particular air flow rate may predict 6 weeks of useful life left, but upon information from other devices, it may indicate the 6 week determination is wrong the predicted time till replacement may instead by 8 weeks instead of 6, thereby changing where the corresponding condition level may be set.

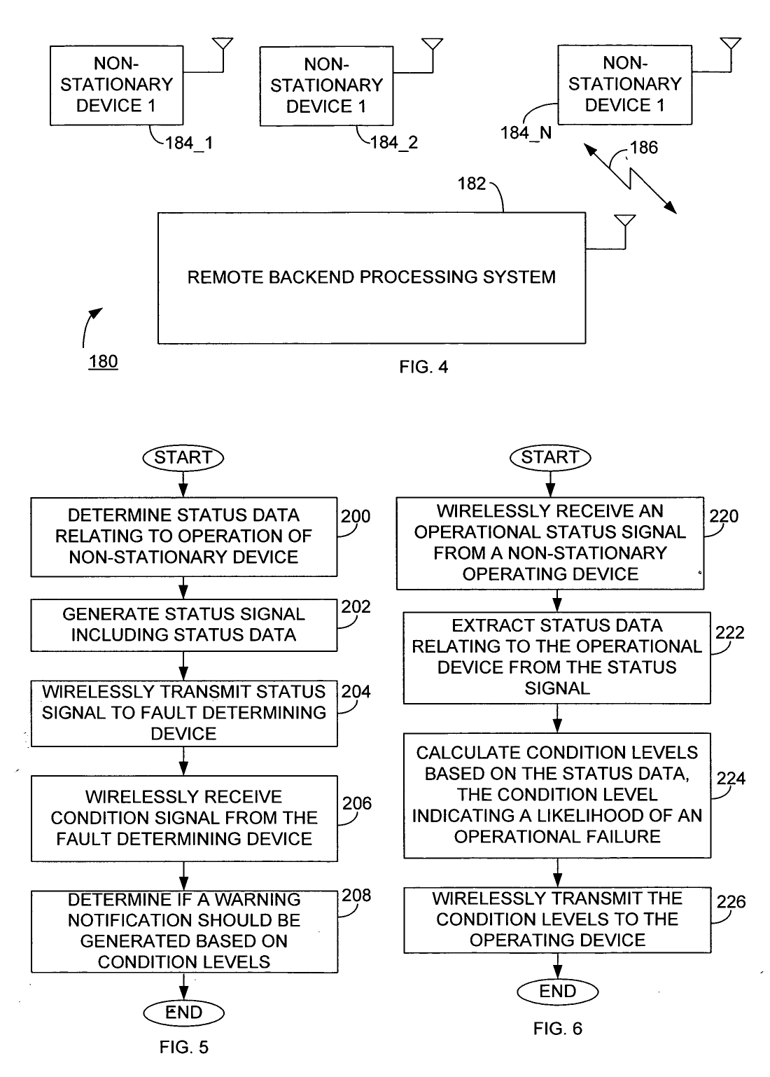

FIG. 4 illustrates one embodiment of a predictive fault determining system 180 including a remote back end processing system 182 and a plurality of non-stationary devices 184 (illustrated at 184_1, 184_2, and 184_N, where N may be any integer value). The remote back end processing system 182 and the non-stationary devices 184 further include wireless transmission capabilities. When the non-stationary devices 184 are within a transmission range, wireless transmissions 186 may be exchanged. For example, in a first transmission the sensor data may be provided to the back end processing system 182. While the back end processing system 182 performs various calculations, the device 184 may move outside of transmission range. Therefore when it is back within transmission range, transmission 186 may include the condition data used to determine a condition level in the non-stationary device 184.

In the system of FIG. 4, any number of non-stationary devices may operate by coming within the transmission range and exchanging the required information for either allowing the processing system 182 to perform back end processing or receive the back end processed calculations. Therefore, the above described system is functional with any number of non-stationary devices which may proceed within and out of transmission range of the back end processing system 182.

FIG. 5 illustrates one embodiment of a method for determining predictive fault determinations from a non-stationary operating device. In one embodiment the method begins at 200 by determining status data of the operation the non-stationary device. Similar to the embodiment described above, status data 142 may be generated by sensors 132. The next step, 202 is generating a status signal that includes the status data. It is recognized that the status signal may include other information as well as data processing of the status data 142 received from the sensors 132.

The next step, step 204, is wirelessly transmitting the status signal to a fault determining device. As described above the wireless signal 110 may be provided to the fault determining device 100 where it is received by the receiver 104. From the perspective of the non-stationary device, the next step, step 206, is wirelessly receiving condition data from the fault determining device, when the condition data includes the condition levels as discussed above. The condition data may be included in the condition data signal.

The following step, step 208, is determining if a warning notification should be generated based on the condition levels. This may be determined by comparing the status data to the condition data in the non-stationary processing device 134. From that information, the non-stationary device determines whether a warning or other type of notification should be generated. Thereupon, in one embodiment, the method is complete.

FIG. 6 illustrates an embodiment of a method for determining predictive fault determinations for a non-stationary operating device. The first step, step 220, is to wirelessly receive an operational status signal from a non-stationary operating device. The operational status signal includes status data relating to the operation of the non-stationary device. The next step, step 222, is to extract the status data relating to the operational device, from the status signal.

The next step, step 224, is to calculate condition data based on the status data, the condition data including condition levels outlining a predictive likelihood of operational failure. The next step 226, is to wirelessly transmit the condition data to the operating device. Therefore, in one embodiment, the method is complete.

Using the back end processing device, setting condition levels for local fault determinations may be performed without requiring extra processing requirements for non-stationary devices. Using wireless transmissions, corresponding information may be provided between the non-stationary device and back end system to allow for the processing this information. When the non-stationary device is within a transmission range or reception range at the back end system, information may be exchanged. Furthermore, in the operation of the non-stationary device, the seamless transmission and reception with back end calculations does not adversely affect operational mobility of the non-stationary device.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A fault determining device comprising:
a wireless receiver operative to wirelessly receive an operational status signal from a non-stationary operating device;
a processing device operative to:
extract status data relating to the operating device from the status signal; and
calculate condition level data for the operational device based on the status data, the condition data defining condition levels that indicate a likelihood of at least one operational failures by the operating device within one of a plurality of time periods; and
a wireless transmitter operative to wirelessly transmit the condition data to the operating device.

2. The fault determining device of claim 1 further comprising:
a database storing additional status data from a plurality of operating devices.

3. The fault determining device of claim 2 wherein the condition data is also calculated based on the additional status data.

4. The fault determining device of claim 1, wherein the status data includes sensor data from a plurality of sensors associated with the operating device.

5. The fault determining device of claim 1 wherein the receiver is operative to receive the status signal when the operating device is within a transmission range and the transmitter is operative to transmit the condition data when the operating device is within a transmission range.

6. A non-stationary operating device comprising:
a plurality of sensors operative to determine a plurality of status data relating to an operation of the operating device;
a processing device operative to combine the status data to generate a status signal;
a transmitter operative to wirelessly transmit the status signal to a fault determining device;
a receiver operative to wirelessly receive condition data signal from the fault determining device, the signal having condition data therein indicating a plurality of condition levels; and
the processing device further operative to determine if at least one warning notification should be generated based on the condition levels.

7. The non-stationary operating device of claim 6 further comprising:
a plurality of notification devices, such that if a warning notification is generated, the notification device provides an output display.

8. The non-stationary operating device of claim 6 wherein the condition data is generated relative to a database of status data by the fault determining device.

9. The non-stationary operating device of claim 6 wherein the transmitter is operative to transmit the status signal when the operating device is within a transmission range and the receiver is operative to receive the condition data when the operating device is within a transmission range.

10. The non-stationary operative device of claim 6 wherein the processing device, in performing the operation of determining if at least one warning notification should be generated is further operative to compare the status data to the condition data to assign one of the plurality of condition levels to thereto, such that the determination of the generation of the warning signal is based on the associated condition level.

11. A method for determining predictive fault determinations for a non-stationary operating device, the method comprising:
wirelessly receiving an operational status signal from the non-stationary operating device;
extracting status data relating to the operating device from the status signal;
calculating condition data for the operational device based on the status data, the condition data including condition levels indicating a likelihood of at least one operational failures by the operating device within one of a plurality of time periods; and
wirelessly transmitting the condition data to the operating device.

12. The method of claim 11 further comprising:
calculating the condition data based on additional status data.

13. The method of claim 11, wherein the status data includes sensor data from a plurality of sensors associated with the operating device.

14. The method of claim 11 further comprising:
wirelessly receiving the status signal when the operating device is within a transmission range of the operating device; and
wirelessly transmitting the condition data when the operating device is within the transmission range of the operating device.

15. A method for determining predictive fault determinations for a non-stationary operating device, the method comprising:
determining a plurality of status data relating to the operation of the operative device;
generating a status signal including the status data;
wirelessly transmitting the status signal to a fault determining device;
wirelessly receiving a condition data signal from the fault determining device, the signal including condition data; and
determining if at least one warning notification should be generated based on the condition data and the status data.

16. The method of claim 15 further comprising:
if a warning notification should be generated, generating at least on warning signal; and
providing the at least one warning signal to at least one output display providing a warning notification.

17. The method of claim 15 wherein the condition data is generated relative to a database of status data by the fault determining device.

18. The method of claim 15 further comprising:
wirelessly transmitting the status signal when the operating device is within a transmission range of the fault determining device; and
wirelessly receiving the condition data signal when the operating device is within the transmission range of the fault determining device.

19. The method of claim 15 wherein the step of determining if at least one warning notification should be generated includes comparing the status data to the condition data to assign one of the plurality of condition levels to thereto, such that the determination of the generation of the warning signal is based on the associated condition level.

20. A predictive fault determining system comprising:
a non-stationary operating device including:
a plurality of sensors operative to determine a plurality of status data relating to the operation of the operating device;
a first processing device operative to combine the status data to generate a status signal; and
a first transmitter operative to wirelessly transmit the status signal to a fault determining device;
a fault determining device including:
a first receiver operative to wirelessly receive the status signal;
a second processing device operative to:
extract status data relating to the operating device from the status signal; and
calculate condition data for the operating device based on the status data, the condition data including condition levels indicating a likelihood of at least one operational failures by the operating device within one of a plurality of time periods; and
a second transmitter operative to wirelessly transmit a condition data signal including the condition data to the operating device; and
the non-stationary operating device further including a second receiver operative to wirelessly receive the condition data signal from the fault determining device, the first processing device operative to compare the status data to the condition data to assign one of the plurality of condition levels to thereto, such that the processing device is further operative to determine if a warning signal should be generated based on the associated condition level.

21. The predictive fault determining system of claim 20 further comprising:
the non-stationary operating device further including a plurality of notification devices, such that if a warning notification is generated, the notification device provides an output display.

22. The predictive fault determining system of claim 20 wherein the first transmitter is operative to transmit the status signal when the operating device is within a transmission range and the second receiver is operative to receive the condition data when the operating device is within a transmission range.

23. The predictive fault determining system of claim 20 further comprising:
the fault determining device further including a database storing additional status data from a plurality of operating device.

24. The predictive fault determining system of claim 23 wherein the condition data is also calculated based on the additional status data.

25. A computer readable medium including executable instructions for determining predictive fault determinations for a non-stationary operating device, the executable instructions, when read by a processing device, provide for:
wirelessly receiving an operational status signal from the non-stationary operating device;
extracting status data relating to the operating device from the status signal;
calculating condition data for the operational device based on the status data, the condition data including condition levels indicating a likelihood of at least one operational failures by the operating device within one of a plurality of time periods; and
wirelessly transmitting the condition data to the operating device.

26. The computer readable medium of claim 25 including further executable instructions that when read by the processing device provide for:
calculating the condition data based on additional status data.

27. The computer readable medium of claim 25, wherein the status data includes sensor data from a plurality of sensors associated with the operating device.

28. The computer readable medium of claim 25 including further executable instructions that when read by the processing device provide for:
wirelessly receiving the status signal when the operating device is within a transmission range of the operating device; and
wirelessly transmitting the condition data when the operating device is within the transmission range of the operating device.

29. A computer readable medium including executable instructions for determining predictive fault determinations for a non-stationary operating device, the executable instructions, when read by a processing device, provide for:
determining a plurality of status data relating to the operation of the operative device;
generating a status signal including the status data;
wirelessly transmitting the status signal to a fault determining device;
wirelessly receiving a condition data signal from the fault determining device, the signal including condition data; and
determining if at least one warning notification should be generated based on the condition data and the status data.

30. The computer readable medium of claim 29 including further executable instructions that when read by the processing device provide for:
if a warning notification should be generated, generating at least on warning signal; and
providing the at least one warning signal to at least one output display providing a warning notification.

31. The computer readable medium of claim 29 wherein the condition data is generated relative to a database of status data by the fault determining device.

32. The computer readable medium of claim 29 including further executable instructions that when read by the processing device provide for:
wirelessly transmitting the status signal when the operating device is within a transmission range of the fault determining device; and
wirelessly receiving the condition data signal when the operating device is within the transmission range of the fault determining device.

33. The computer readable medium of claim 29 wherein the step of determining if at least one warning notification should be generated includes comparing the status data to the condition data to assign one of the plurality of condition levels to thereto, such that the determination of the generation of the warning signal is based on the associated condition level.
